(19) United States
(12) Patent Application Publication
(10) Pub. No.: US 2025/0036340 A1
(43) Pub. Date: Jan. 30, 2025

(54) INFORMATION PROCESSING APPARATUS AND CONTROL METHOD

(71) Applicant: SHARP KABUSHIKI KAISHA, Sakai City (JP)

(72) Inventors: YUSAKU IKEDA, Sakai City (JP); Yuichi Sato, Sakai City (JP); Shuji Daioku, Sakai City (JP)

(21) Appl. No.: 18/785,040

(22) Filed: Jul. 26, 2024

(30) Foreign Application Priority Data
Jul. 28, 2023 (JP) 2023-122911

(51) Int. Cl. G06F 3/14

(52) U.S. Cl. CPC G06F 3/14

(57) ABSTRACT

A head-mounted information processing apparatus includes: a communication unit configured to communicate with an external apparatus; an imaging unit configured to generate a captured image by imaging a given imaging range; a display unit configured to display an image; and a controller, wherein the imaging unit generates the captured image in which an input interface is imaged, by imaging the imaging range including the input interface connected to the external apparatus, and the controller performs control for causing an image acquired from the external apparatus to be displayed in a first display region that is a part of a display region of the display unit, and causing the captured image including the input interface to be displayed in a second display region that is another part of the display region.

### CROSS-REFERENCE TO RELATED APPLICATION

The present application claims priority from Japanese Application JP2023-122911, the content of which is hereby incorporated by reference into this application.

### BACKGROUND OF THE INVENTION

### 1. Field of the Invention

The disclosure relates to an information processing apparatus and a control method.

### 2. Description of the Related Art

In the related art, a head mounted display (HMD) is widely known that is a head-mounted information processing apparatus. For example, a service using a virtual reality (VR) technology with a sense of immersion can be provided by covering the field of view of a user using the HMD. Japanese Unexamined Patent Application Publication No. 2021-125834 discloses a method of displaying an image obtained by capturing a top plate of a desk on a desk object in a virtual space in a case that the HMD is used.

### SUMMARY

A technique uses a keyboard or a mouse formed in a virtual space as operation input during mounting of the HMD. However, this input cannot be said to be efficient. The technique disclosed in Japanese Unexamined Patent Application Publication No. 2021-125834 merely displays an actual image of the periphery of the hands of the user, and is not specialized for input using a keyboard or the like.

According to some aspects of the present disclosure, an information processing apparatus, a control method, and the like can be provided that facilitate operation input using an input interface.

An aspect of the present disclosure provides a head-mounted information processing apparatus including a communication unit configured to communicate with an external apparatus, an imaging unit configured to generate a captured image by imaging a given imaging range, a display unit configured to display an image, and a controller, wherein the imaging unit generates the captured image in which an input interface is imaged, by imaging the imaging range including the input interface connected to the external apparatus, and the controller performs control for causing an image acquired from the external apparatus to be displayed in a first display region that is a part of a display region of the display unit, and causing the captured image including the input interface to be displayed in a second display region that is another part of the display region.

Another aspect of the present disclosure provides a control method for a head-mounted information processing apparatus including a communication unit configured to communicate with an external apparatus, an imaging unit configured to generate a captured image by imaging a given imaging range, and a display unit configured to display an image, the control method including generating the captured image in which an input interface is imaged, by imaging the imaging range including the input interface connected to the external apparatus, and performing control for displaying the image acquired from the external apparatus in a first display region that is a part of a display region of the display unit, and displaying the captured image including the input interface in a second display region that is another part of the display region.

### BRIEF DESCRIPTION OF THE DRAWINGS

FIG. 1A is a configuration example of an information processing system including an information processing apparatus.

FIG. 1B is a configuration example of an information processing system including an information processing apparatus.

FIG. 2 is a perspective view illustrating a configuration example of the information processing apparatus.

FIG. 3 is a configuration example of an information processing apparatus.

FIG. 4 is a flowchart illustrating processing in the information processing apparatus.

FIG. 5 is an example of a screen displayed on a display unit of the information processing apparatus.

### DETAILED DESCRIPTION OF THE INVENTION

The present embodiment will be described below with reference to the drawings. In the drawings, the same or equivalent elements are denoted by the same reference numerals and duplicate description will be omitted. Note that the present embodiment described below is not to unreasonably limit the contents described in Claims. Not necessarily all of the configurations described in the present embodiment are essential configuration requirements of the present disclosure.

### 1. System Configuration Example

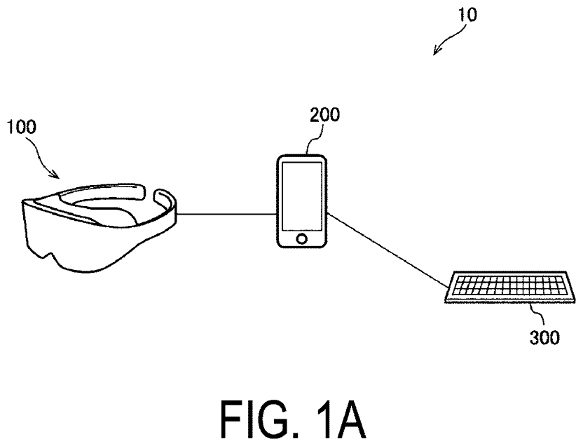

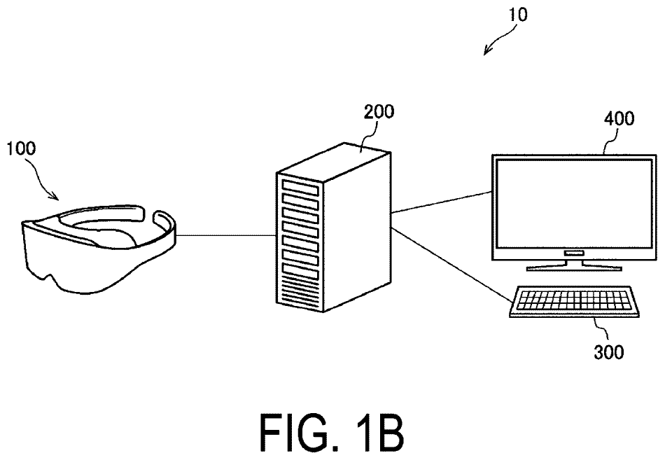

FIG. 1A and FIG. 1B are each a diagram illustrating a configuration example of an information processing system 10 including an information processing apparatus 100 of the present embodiment. The information processing system 10 includes an information processing apparatus 100, an external apparatus 200, and an input interface 300.

The information processing apparatus 100 is an apparatus that can be worn by a user and allows the user to experience a virtual reality space. For example, the information processing apparatus 100 is a head-mounted display that can be mounted on the head of the user. Note that the information processing apparatus 100 is not limited to an apparatus that performs only processing for causing a user to experience a virtual reality space, and may be capable of presenting a planar image to the user.

The external apparatus 200 is an apparatus configured separately from the information processing apparatus 100. The external apparatus 200 may be, for example, a smartphone as illustrated in FIG. 1A, a personal computer (PC) as illustrated in FIG. 1B, or another apparatus connectible to the information processing apparatus 100.

The information processing apparatus 100 is connected to the external apparatus 200. The information processing apparatus 100 and the external apparatus 200 may be connected to each other in a wired manner using a cable conforming to a standard such as Universal Serial Bus (USB), DisplayPort, or High-Definition Multimedia Interface (HDMI), or may be connected to each other in a wireless manner using a communication method conforming to a standard such as Bluetooth (registered trademark) or IEEE 802.11. A method used for the connection between the information processing apparatus 100 and the external apparatus 200 is not limited to that in the above example, and can be subjected to many variations.

The input interface 300 is equipment connected to the external apparatus 200 and used as a user interface of the external apparatus 200. The external apparatus 200 and the input interface 300 may be wire-connected using a USB cable or the like, or may be wirelessly connected using a communication method according to Bluetooth or the like.

The input interface 300 is a tool existing in the real space. In other words, the input interface 300 is not a tool displayed on a display or a tool formed in a virtual space. The input interface 300 may be a physical keyboard or a pointing device such as a mouse. An example in which the input interface 300 is a physical keyboard will be described below.

Note that FIG. 1B illustrates an example in which a display 400 serving as a display unit is connected to the external apparatus 200 serving as a PC. However, in the technique of the present embodiment, an image output from the external apparatus 200 can be displayed on the information processing apparatus 100 as will be described later, and thus the display 400 of the external apparatus 200 may be omitted. A device other than the input interface 300 and the display 400 may be connected to the external apparatus 200.

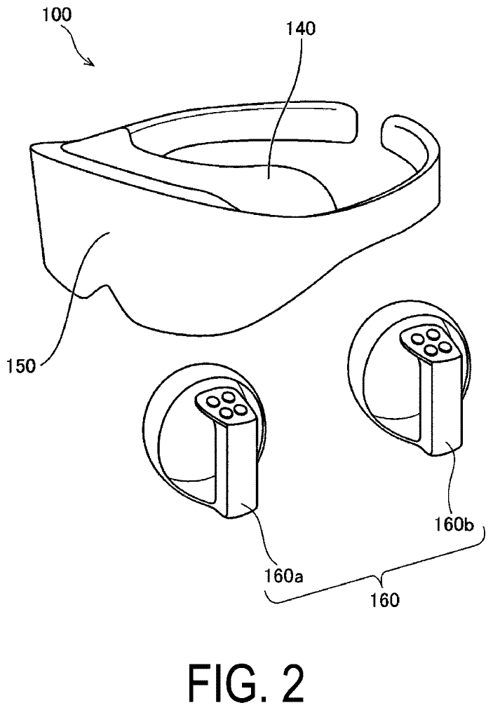

FIG. 2 is a diagram illustrating a configuration example of the information processing apparatus 100. The information processing apparatus 100 includes a display unit 140, an imaging unit 150, and an operation unit 160.

The display unit 140 includes a right-eye display disposed in front of the right eye of the user and a left-eye display disposed in front of the left eye of the user. The display unit 140 performs stereoscopic display by displaying different images on the left and right sides. For example, the display unit 140 includes a liquid crystal display, an organic Electro-Luminescence (EL) display, or the like. Alternatively, the display unit 140 may include one display, the region of which is divided into a region in which video for the right eye is displayed and a region in which video for the left eye is displayed within the one display.

The imaging unit 150 generates a captured image by imaging a given imaging range in the real space. The imaging unit 150 may be, for example, a camera that images the front direction of the information processing apparatus 100. By displaying the captured image on the display unit 140, information of the real space can be presented to the user.

Note that variations can be made to the number of the imaging units 150, and the arrangement position, the imaging direction (direction of the optical axis), the width of angle of view, and the like for the imaging units 150. For example, the imaging unit 150 is a camera capable of capturing an image in the front direction, and the range to be captured may be changed by the user wearing the information processing apparatus 100 changing the direction of the face. For example, in a case that the user turns the face of the user downward, the imaging unit 150 captures an image of the hands of the user. The imaging unit 150 may include multiple imaging units respectively having different image capturing ranges. For example, the imaging unit 150 may include a first imaging unit that captures an image in the front direction and a second imaging unit that captures an image from above (the hands of the user).

The operation unit 160 is an interface used for operating the information processing apparatus 100. FIG. 2 illustrates an operation unit 160a for the left hand and an operation unit 160b for the right hand as the operation unit 160. The user performs operation by, for example, gripping a grip portion of the operation unit 160a, and pressing a button provided at an upper end portion of the grip or changing the position or the angle of the operation unit 160a. The same applies to the operation unit 160b for the right hand. The operation units 160a and 160b are connected to the main body (goggle portion) of the information processing apparatus 100 in a wired or wireless manner, for example. Although not illustrated in FIG. 2, the operation unit 160 may include a button or the like provided on the main body of the information processing apparatus 100.

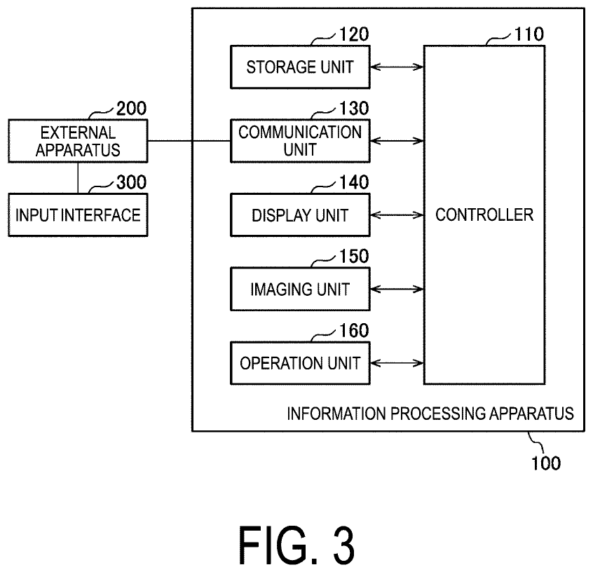

FIG. 3 is a block diagram illustrating a configuration example of the information processing apparatus 100. The information processing apparatus 100 includes a controller 110, a storage unit 120, a communication unit 130, the display unit 140, the imaging unit 150, and the operation unit 160.

The controller 110 is connected to each unit of the information processing apparatus 100 and controls each unit. The controller 110 includes the following hardware. The hardware can include at least one of a circuit for processing a digital signal and a circuit for processing an analog signal. For example, the hardware can include one or multiple circuit apparatuses or one or multiple circuit elements implemented in a circuit substrate. Each of the one or multiple circuit apparatuses is an Integrated Circuit (IC), a field-programmable gate array (FPGA), or the like, for example. Each of the one or multiple circuit elements is a resistor, a capacitor, or the like, for example.

The controller 110 may be implemented with the following processor. The information processing apparatus 100 of the present embodiment includes a memory that stores information and a processor that operates based on the information stored in the memory. The information is a program, various pieces of data, and the like, for example. The processor includes hardware. The processor can use various processors, such as a Central Processing Unit (CPU), a Graphics Processing Unit (GPU), and a Digital Signal Processor (DSP). The memory may be a semiconductor memory such as a Static Random Access Memory (SRAM), and a Dynamic Random Access Memory (DRAM), may be a resistor, may be a magnetic storage apparatus such as a Hard Disk Drive (HDD), or may be an optical storage apparatus such as an optical disc apparatus. For example, the memory stores an instruction that can be read by a computer, and with the processor performing the instruction, the function of the controller 110 is implemented as processing. The instruction in this case may be an instruction of a set of instructions constituting a program, or may be an instruction for indicating operation to a hardware circuit of the processor.

The storage unit 120 is a working area of the controller 110, and stores various pieces of information. The storage unit 120 can be implemented with various memories, and each of such memories may be a semiconductor memory, may be a resistor, may be a magnetic storage apparatus, or may be an optical storage apparatus.

The communication unit 130 is an interface for performing communication via a network. The communication unit 130 may include an antenna, a radio frequency (RF) circuit, and a baseband circuit in a case that the communication unit 130 performs, for example, wireless communication. However, the communication unit 130 may perform wired communication, and the communication unit 130 in this case may include a communication interface such as an Ethernet connector, a control circuit of the communication interface, and the like. The communication unit 130 may operate under the control of the controller 110 or may include a processor for communication control that is different from the controller 110.

The communication unit 130 according to the present embodiment communicates with, for example, the external apparatus 200. As described above, the communication method between the information processing apparatus 100 and the external apparatus 200 can be varied, and the communication unit 130 may be a connector such as USB, DisplayPort, or HDMI, a communication chip for Bluetooth, a communication chip for IEEE802.11, or any other communication interface.

The display unit 140 is a display for the HMD as described above. The imaging unit 150 is a camera or the like that captures an image of the real space. The operation unit 160 is an operation interface such as the operation units 160a and 160b illustrated in FIG. 2.

In the information processing system 10 illustrated in FIGS. 1A and 1B, for example, the controller 110 of the information processing apparatus 100 performs control for acquiring an image from the external apparatus 200 via the communication unit 130 and for displaying the image on the display unit 140. The image here may be an image acquired by the external apparatus 200 from another apparatus. For example, the external apparatus 200 that is a smartphone may communicate with a server system that provides a cloud service. The external apparatus 200 acquires an image (for example, a service use screen) from the server system and transmits the image to the information processing apparatus 100. In this way, the information processing apparatus 100 can use the cloud service via the external apparatus 200. The cloud service here may be a service using various applications such as documentation, table creation, and image editing, or may be a distribution service for video contents such as movies. The use of the cloud service is not essential, and the information processing apparatus 100 may acquire an image generated by the external apparatus 200.

However, in a case that the HMD is used as a display apparatus for a case in which an application is used, the operation unit 160 of the HMD may have difficulty in performing a sufficient operation depending on the type of the application. For example, various applications provided by an OS such as Windows (registered trademark) include applications that assume operations using a mouse and a keyboard. The virtual input interface has a problem in terms of usability such as the lack of physical feedback (for example, push-back of keys).

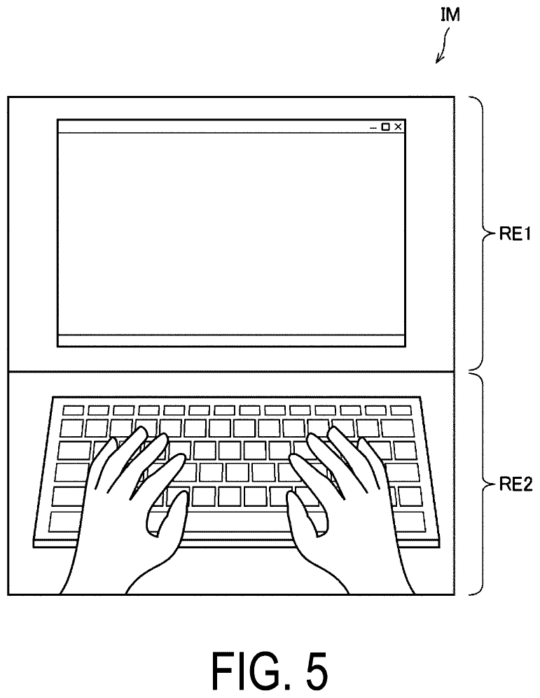

Thus, in the information processing apparatus 100 according to the present embodiment, a physical interface is used by displaying a captured image of the input interface 300 connected to the external apparatus 200. Specifically, the information processing apparatus 100 according to the present embodiment is a head-mounted information processing apparatus and includes the communication unit 130, the imaging unit 150, the display unit 140, and the controller 110. The imaging unit 150 generates a captured image of the input interface 300 imaged by capturing an image of an imaging range including the input interface 300 connected to the external apparatus 200. The imaging unit 150 may be provided that captures an image from above in such a manner that the physical keyboard located close to the hands of the user is imaged with the user facing in the front direction, or the user may look downward to cause the imaging unit 150, which otherwise captures an image in the front direction, images the physical keyboard located close to the hands of the user. Then, the controller 110 performs control for causing an image acquired from the external apparatus 200 to be displayed in a first display region RE1 that is a part of the display region of the display unit 140 and for causing a captured image including the input interface 300 to be displayed in a second display region RE2 that is another part of the display region. Hereinafter, the image displayed by the control is also referred to as a display image IM. A specific example of the display image IM will be described later with reference to FIG. 5.

The captured image with the input interface 300 such as a physical keyboard imaged is displayed in a part of the display region, and thus the user can perform operation while visually recognizing the state of the physical keyboard present in the real space, the positional relationship between the physical keyboard and the hands of the user, and the like. In the present embodiment, the equipment that provides the information processing apparatus 100 with the image displayed in the first display region RE1 is the same as the equipment to which the input interface 300 is connected (external apparatus 200). Therefore, an operation result for the input interface 300 can be used for operation of the application or the like being displayed without performing complicated linkage control.

A part or all of the processing performed by the information processing apparatus 100 of the present embodiment may be implemented with a program. The processing performed by the information processing apparatus 100 is processing performed by the controller 110 in a narrow sense.

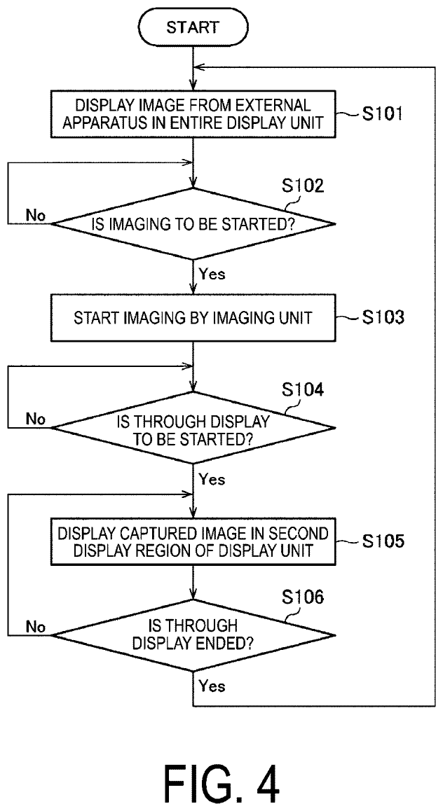

The program according to the present embodiment can be stored in a non-transitory information storage medium (information storage apparatus), which is a computer-readable medium, for example. The information storage medium can be implemented with an optical disc, a memory card, an HDD, a semiconductor memory, or the like, for example. The semiconductor memory is a ROM, for example. The controller 110 and the like perform various processes of the present embodiment based on the program stored in the information storage medium. In other words, the information storage medium stores the program for causing a computer to function as the controller 110 and the like. The computer is an apparatus including an input apparatus, a processing unit, a storage unit, and an output unit. Specifically, the program according to the present embodiment is a program for causing the computer (specifically the HMD) to perform each step described below with reference to FIG. 4 and the like.

The technique of the present embodiment can be applied to a control method for a head-mounted information processing apparatus including a communication unit that performs communication with an external apparatus, an imaging unit that generates a captured image by imaging a given imaging range, and a display unit that displays an image. The control method includes the step of capturing an image of an imaging range including an input interface connected to an external apparatus to generate a captured image with the input interface imaged and the step of performing control for displaying an image acquired from the external apparatus in a first display region that is a part of a display region of a display unit and for displaying the captured image including the input interface in a second display region that is another part of the display region.

### 2. Details of Processing

### 2.1 Flow of Processing

FIG. 4 is a flowchart illustrating processing in the information processing apparatus 100. In a case that this processing is started, in step S101, the controller 110 performs control for causing the display unit 140 to display an image acquired from the external apparatus 200. In step S101, the controller 110 does not perform control for causing the captured image to be displayed. For example, the controller 110 may display the image acquired from the external apparatus 200 using the entire display region of the display unit 140.

In step S102, the controller 110 determines whether to start imaging by the imaging unit 150. Details of the determination processing in step S102 will be described later. In a case that the imaging is determined not to be started (step S102: No), the controller 110 returns to step S102 and periodically performs similar determination. In other words, the controller 110 continues to display only the image acquired from the external apparatus 200 while keeping the imaging unit 150 off (or in a standby state).

In a case that the imaging is determined to be started (step S102: Yes), in step S103, the controller 110 performs control for turning on the imaging unit 150. Thus, acquisition of the captured image captured by the imaging unit 150 is started.

In step S104, the controller 110 determines whether to start through display. Through display refers to display control for displaying the captured image to present information of the real space to the user wearing the HMD. Details of the determination processing in step S104 will be described later.

Note that the through display may include, in a broad sense, control for displaying, in the entire display region of the display unit 140, a captured image having a range equivalent to the field of view of the user (presenting the information of the real space in such a manner that the user feels like not wearing the HMD), but in the following description, the through display represents control for simultaneously displaying the image from the external apparatus 200 and the captured image.

In a case that the through display is not to be performed (No in step S104), the controller 110 returns to step S104 and periodically performs similar determination. In other words, while acquiring the captured image, the controller 110 continues, for display, the display control for only the image acquired from the external apparatus 200.

In a case that the through display is determined to be started (step S104: Yes), in step S105, the controller 110 performs the through display by continuing the display of the image from the external apparatus 200 in the first display region RE1 of the display unit 140, while causing the captured image (display image IM) to be displayed in the second display region RE2.

FIG. 5 illustrates an example of the display image IM provided in a case that the through display is performed. For example, the first display region RE1 may be an upper region of the display region of the display unit 140, and the second display region RE2 may be a lower region of the display region of the display unit 140. With this configuration, the positional relationship between the display screen (the first display region RE1) for the application or the like and the keyboard (the second display region RE2) can be made similar to a positional relationship observed in a case that a general PC or the like is used. This allows realization of an interface that is easy for the user to use. Although FIG. 5 illustrates an example in which a window corresponding to a given application is displayed in the first display region RE1, the image displayed in the first display region RE1 is not limited to this, and various images output from the external apparatus 200 can be displayed.

As illustrated in FIG. 5, each of the first display region RE1 and the second display region RE2 may be a rectangular region. However, the position, size, and shape of each of the first display region RE1 and the second display region RE2 are not limited to those in the example of FIG. 5, and can be subjected to many variations. The first display region RE1 and the second display region RE2 are not limited to exclusive regions (regions that do not overlap), and may partially overlap each other. In this case, in the overlapping region, one image may be subjected to transparency processing, and then may be superimposed on the other image.

As illustrated in FIG. 5, since the captured image including the physical keyboard is displayed in the second display region RE2, in a case that the hands of the user are present in the imaging range (for example, on the physical keyboard), the hands are also included in the captured image. Accordingly, the positional relationship between the hands and the physical keyboard can be presented to the user, leading to easier operation. The image displayed in the second display region RE2 may be the entire captured image or may be a partial region of the captured image including the physical keyboard.

After the start of the through display, in step S106, the controller 110 determines whether to end the through display. For example, in a case that a predetermined operation is performed on the operation unit 160 of the information processing apparatus 100, the controller 110 determines to end the through display. Alternatively, the controller 110 may determine to end the through display in a case that a predetermined operation is performed on the physical keyboard. However, in a case that the physical keyboard is used, an operation for ending the through display needs to be distinguished from a normal operation for the application or the like. Thus, an operation having a sufficiently low probability of being performed in the normal operation may be set as the operation for ending the through display.

In a case that the through display is determined not to be ended (step S106: No), the controller 110 returns to step S105 and continues the processing. Specifically, the through display (display of the display image IM) is continued. In a case that the through display is determined to be ended (step S106: Yes), the controller 110 returns to step S101 and continues the processing. Specifically, the controller 110 performs control for turning off the imaging unit 150 and control for displaying only the image from the external apparatus 200 on the display unit 140.

In a case that the through display is determined not to be ended (step S106: No), the controller 110 may return to step S104 and continue the processing. Specifically, while keeping the imaging unit 150 on, the controller 110 may transition to a state in which the through display is not performed. In addition, the flow of processing in the information processing apparatus 100 is not limited to that in FIG. 4, and can be subjected to many variations.

### 2.2 First Example of Determination Processing

Next, several specific examples of imaging start determination (step S102) and through display start determination (step S104) in FIG. 4 will be described.

The communication unit 130 may acquire, from the external apparatus 200, operation information indicating that a user operation on the input interface 300 has been detected. As described above, since the input interface 300 is an interface connected to the external apparatus 200, the external apparatus 200 can easily acquire an operation result for the input interface 300. The external apparatus 200 outputs information representing the operation result to the information processing apparatus 100 as operation information. Then, in a case of acquiring the operation information, the controller 110 may start control for displaying the captured image in the second display region RE2. In other words, the through display start determination illustrated in step S104 of FIG. 4 may be processing for determining whether a user operation has been performed on the input interface 300. In this way, in a case that the user has a high probability of using the input interface 300, the state of the input interface 300 can be presented using the through display.

Note that the user operation here is not an operation limited to a specific key, but may be an operation performed on an arbitrary key. For example, even in a state in which the user wears the HMD, the user is considered to remember the approximate position of the physical keyboard based on the positional relationship observed before the user wears the HMD. Therefore, in a case that the user wants to operate the physical keyboard, even in a state where the user cannot visually recognize the physical keyboard, it is relatively easy to find the physical keyboard with fumbling and operate any key. In other words, by avoiding extremely limiting the content of the user operation, the user can appropriately perform the operation for starting the through display. However, the user operation here is not prevented from being an operation on a specific key (for example, the Enter key, which is relatively large, the Escape key, located at the upper left end, or the like) of the physical keyboard.

In a case of acquiring the operation information, the controller 110 may perform control for causing the imaging unit 150 to start imaging. In other words, the imaging start determination illustrated in step S102 of FIG. 4 may also be processing for determining the presence or absence of a user operation on the input interface 300, as in the case of the through display start determination. In this way, imaging is started in a case that the necessity of the through display is sufficiently high. The imaging unit 150 is not activated in a case that the necessity of the through display is low, and thus the imaging unit 150 enables suppression of power consumption and the like.

Note that the flowchart depicted in FIG. 4 illustrates an example in which the imaging start determination (step S102) and the through display start determination (step S104) are different steps, but that the different steps may be combined into one step. For example, in the above-described example, the controller 110 may determine whether a user operation on the input interface 300 is detected, and may cause the imaging unit 150 to start imaging and the display unit 140 to start the through display in a case that the user operation has been detected.

However, in a case that the operation of the input interface 300 is used as the start a trigger for the through display, the start a trigger for the imaging may be different from the operation. For example, in a case of receiving an operation input to the operation unit 160 of the information processing apparatus 100, the controller 110 may perform control for causing the imaging unit 150 to start imaging. In this way, the user can give an indication to start imaging using the interface (the operation unit 160), which is easy to use even in a case that the user wears the HMD.

### 2.3 Second Example of Determination Processing

The trigger for starting the through display may be based on image processing. For example, on the assumption that the imaging by the imaging unit 150 has been started, the controller 110 may perform image processing for detecting the input interface 300 from the captured image generated by the imaging unit 150. Note that various methods are known for object detection processing for detecting a specific object from an image, and these methods can be widely applied in the present embodiment, and thus a detailed description thereof will be omitted.

In a case of determining that the captured image includes the input interface 300, the controller 110 starts control for causing the captured image to be displayed in the second display region RE2. For example, in the case where the image processing is processing for determining the presence or absence of an object using binary values, the controller 110 starts the through display in a case of detecting the input interface 300. In a case that the image processing is processing for outputting a score indicating the likelihood of the object, the controller 110 may start the through display in a case that the score related to the input interface 300 is greater than or equal to a predetermined threshold value.

In a case that the captured image does not include the input interface 300, there is a possibility that the display of the captured image does not contribute to improvement in operability. In this regard, by using a detection result for the input interface 300, the display of the captured image can be started in a case that the through display is effective. Note that the controller 110 may perform determination based on the position or size of the input interface 300 in the captured image. For example, the controller 110 may start the through display in a case that the input interface 300 is located in the vicinity of the center of the captured image and has a certain size or larger.

The controller 110 may perform image processing for detecting the hands of the user from the captured image generated by the imaging unit 150. In a case that the captured image includes the input interface 300 and the hands of the user are detected at the position overlapping the input interface 300, the controller 110 may start control for causing the captured image to be displayed in the second display region RE2.

In a case that the user performs operation using the input interface 300, the hands of the user are assumed to be positioned in the vicinity of the input interface 300 (for example, a state illustrated in the second display region RE2 in FIG. 5). Therefore, by performing the determination regarding the hands of the user in addition to the presence or absence of the input interface 300, the through display can be started in a case that the user is estimated to have a high probability of operating the input interface 300.

Note that in a case that image processing is used as a trigger for starting the through display, a captured image needs to be acquired before the image processing. Therefore, the controller 110 determines whether to start imaging by a method different from image processing. For example, in a case of receiving an operation input to the operation unit 160 of the information processing apparatus 100, the controller 110 may perform control for causing the imaging unit 150 to start imaging. In this way, the user can give an indication to start imaging using the interface, which is easy to use even in a case that the user wears the HMD.

### 2.4 Third Example of Determination Processing

In a case of receiving an operation input to the operation unit 160 of the information processing apparatus 100, the controller 110 may start control for displaying the captured image in the second display region RE2. With this configuration, the user can give an indication to start the through display using the interface, which is easy to use even in a case that the user wears the HMD.

In this case, in a case that the displayed captured image includes the imaged input interface 300, the user can immediately start an operation using the input interface 300. Even in a case that the captured image does not include the input interface 300, since the through display has been started, the user can search for the input interface 300 based on the information of the real space displayed in the second display region RE2.

Note that, although the present embodiment has been described in detail as in the above, it shall be easily understood by a person skilled in the art that numerous modifications can be made without substantially departing from new matters and effects of the present embodiment. Accordingly, such modifications are all included within the scope of the present disclosure. For example, a term that is at least once described with a different term having a wider meaning or the same meaning in the specification or the drawings can be replaced with the different term in any part of the specification or the drawings. All of combinations of the present embodiment and the modifications are also included within the scope of the present disclosure. The configurations, the operations, and the like of the information processing apparatus, the external apparatus, the input interface, and the like are not limited to those described in the present embodiment, and can be subjected to many variations.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A head-mounted information processing apparatus comprising:
a communication unit configured to communicate with an external apparatus;
an imaging unit configured to generate a captured image by imaging a given imaging range;
a display unit configured to display an image; and
a controller, wherein
the imaging unit generates the captured image in which an input interface is imaged, by imaging the imaging range including the input interface connected to the external apparatus, and
the controller performs control for causing an image acquired from the external apparatus to be displayed in a first display region that is a part of a display region of the display unit, and causing the captured image including the input interface to be displayed in a second display region that is another part of the display region.

2. The information processing apparatus according to claim 1, wherein
the communication unit acquires, from the external apparatus, operation information indicating that a user operation on the input interface has been detected, and
the controller starts control for causing the captured image to be displayed in the second display region in a case that the operation information is acquired.

3. The information processing apparatus according to claim 2, wherein
the controller performs control for causing the imaging unit to start imaging in a case that the operation information is acquired.

4. The information processing apparatus according to claim 2, further comprising:
an operation unit on which a user performs an operation input, wherein
the controller performs control for causing the imaging unit to start imaging in a case that the operation input to the operation unit is received.

5. The information processing apparatus according to claim 1, wherein
the controller
performs image processing for detecting the input interface from the captured image generated by the imaging unit, and
starts control for causing the captured image to be displayed in the second display region in a case of determining that the captured image includes the input interface.

6. The information processing apparatus according to claim 5, wherein
the controller
performs image processing for detecting a hand of a user from the captured image generated by the imaging unit, and
starts control for causing the captured image to be displayed in the second display region in a case that it is determined that the captured image includes the input interface and the hand of the user has been detected at a position overlapping with the input interface.

7. The information processing apparatus according to claim 5, further comprising:
an operation unit on which a user performs an operation input, wherein
the controller performs control for causing the imaging unit to start imaging in a case that the operation input to the operation unit is received.

8. The information processing apparatus according to claim 1, further comprising:
an operation unit on which a user performs an operation input, wherein
the controller starts control for causing the captured image to be displayed in the second display region in a case that the operation input to the operation unit is received.

9. The information processing apparatus according to claim 1, wherein
the first display region is an upper region of the display region of the display unit, and
the second display region is a lower region of the display region of the display unit.

10. A control method for a head-mounted information processing apparatus comprising a communication unit configured to communicate with an external apparatus, an imaging unit configured to generate a captured image by imaging a given imaging range, and a display unit configured to display an image, the control method comprising:
generating the captured image in which an input interface is imaged, by imaging the imaging range including the input interface connected to the external apparatus, and
performing control for displaying the image acquired from the external apparatus in a first display region that is a part of a display region of the display unit and displaying the captured image including the input interface in a second display region that is another part of the display region.
